(19) United States
(12) Patent Application Publication
(10) Pub. No.: US 2002/0100311 A1
(43) Pub. Date: Aug. 1, 2002

(54) OIL IN AIR INDICATOR

(76) Inventors: ESLEY EDDY JR., NORTH RIDGEVILLE, OH (US); JOHN MAYER, WESTLAKE, OH (US); MARK D. JOHNSON, GRAFTON, OH (US); JOHN A. KINSLEY, WESTLAKE, OH (US); GENE GILBERT, ELYRIA, OH (US)

Correspondence Address: CALFEE HALTER & GRISWOLD, LLP, 800 SUPERIOR AVENUE, SUITE 1400, CLEVELAND, OH, 44114, US

(21) Appl. No.: 09/479,158

(22) Filed: Jan. 7, 2000

(51) Int. Cl. G01N 29/02

(52) U.S. Cl. 73/24.04; 73/1.01

(57) ABSTRACT

An oil in air test apparatus measures the quantity of oil vapor entrained in the air stream from an air compressor used to generate compressed air for a vehicle air brake system. Testing is accomplished while the air compressor is in service and mounted onto the engine of the vehicle. The test apparatus creates back pressure to simulate an operating load on the air compressor, and passes an air stream through a disposable oil in air indicator cartridge to capture oil entrained in the air stream. Visual examination of the indicator cartridge is utilized to determine the operation condition of the air compressor. The test apparatus allows the operator to determine whether or not the quantity of oil vapor carried over in the compressed air is within acceptable warranty tolerances. As a result, unnecessary warranty calls for air compressors which are passing oil within normal tolerances are prevented.

### FIELD OF THE INVENTION

The invention relates in general to an apparatus for detecting the presence of oil in an air stream. More specifically, the invention provides an apparatus and method to measure the quantity of oil that is entrained in air supplied by an engine mounted air compressor to a vehicle braking system.

### BACKGROUND OF THE INVENTION

Truck mounted air compressors for air brake systems have been experiencing high warranty costs due to consumer complaints of excessive oil vapor entrained in the air stream. Historical warranty analysis, however, indicates the majority of air compressors that are returned due to excessive oil vapor passing in the air stream are actually operating within acceptable warranty tolerances. It therefore appears that a major contributor to high warranty costs is the consumer's incorrect perception of the amount of oil the air compressor is discharging, as technicians often discover that the quantity of oil passed is well within normal warranty tolerances when testing air compressors rejected by the consumer.

Unnecessary warranty service calls are undesirable for the manufacturers, dealers, distributors, and end-users. Removing a functional air compressor from the engine, shipping it back to the factory, and disabling a truck while it is in the service bay generates unwanted truck downtime, labor costs, handling costs, and delays for all of the parties involved. As a result, there is a need for an apparatus and method of testing the amount of oil passed by an air compressor while it is still mounted on the truck engine.

In view of the above, it is an object of the invention to provide an apparatus and method for accurately and repeatedly quantifying the amount of oil vapor which is passed by an air compressor under normal operating conditions, and thereby determine whether the amount of oil passed is within acceptable warranty tolerances.

### SUMMARY OF THE INVENTION

The present invention provides a test apparatus and method that measures the quantity of oil vapor entrained in an air stream generated by an air compressor for a vehicle air brake system. Testing is accomplished while the air compressor is in service and mounted onto the engine of the vehicle. The test apparatus creates back pressure to simulate an operating load on the air compressor. Using a disposable oil in air indicator cartridge, the test apparatus accurately measures the quantity of oil vapor that is entrained in the air stream generated by the air compressor. The test apparatus allows the operator to determine whether the quantity of oil vapor carried in the compressed air is within acceptable warranty tolerances. As a result, unnecessary warranty calls for air compressors that are passing oil within normal tolerances are prevented.

In a preferred embodiment, the test apparatus includes a test air inlet port, a test air outlet port, and a valve manifold coupled between the test air inlet port and the test air outlet port. The valve manifold includes a regulating valve that regulates an air pressure of an air stream passing through the valve manifold and a diverting valve that diverts the air stream from the test air outlet port to an exhaust port. An oil in air indicator coupled to the test air outlet port. The oil in air indicator includes a main body portion having an inlet end and an outlet end, wherein the main body portion is filled with an oil indicator material. First and second air permeable end pieces are respectively located at the inlet end and the outlet end of the main body portion of the oil in air indicator to preferably retain the oil indicator material within the main body portion while allowing air to pass through. An air pressure gauge and air temperature gauge are also preferably provided so that the pressure and temperature of the air stream can be monitored. For the convenience of the operator, a timer is also provided within the test apparatus to time the duration of the test procedure.

Other advantages and features of the invention will become apparent from the following detailed description of the preferred embodiments and the accompanying drawings.

### BRIEF DESCRIPTION OF THE DRAWINGS

The invention will now be described with reference to certain preferred embodiments thereof and the accompanying drawings, wherein:

FIG. 1 is a front view of the oil in air test apparatus in accordance with the invention;

FIG. 2 is a front cross sectional view of a valve manifold of the test apparatus illustrated in FIG. 1;

FIG. 3 is a bottom cross sectional view of the valve manifold;

FIG. 4 is a side cross sectional view of an oil in air indicator cartridge in accordance with the invention;.

FIG. 5 is an end view of the indicator cartridge illustrated in FIG. 4;

FIG. 6 is a side view of the indicator cartridge showing oil saturating the oil indicator material contained therein.

### DETAILED DESCRIPTION OF THE PREFERRED EMBODIMENTS

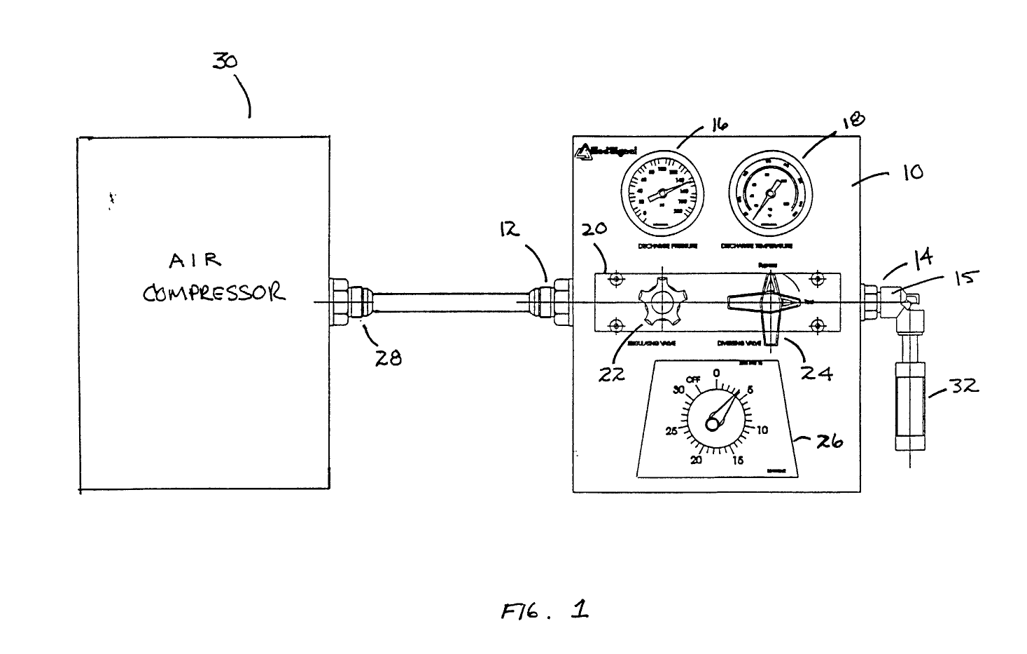

FIG. 1 illustrates an oil in air test apparatus 10, in accordance with a preferred embodiment of the invention, that includes a test air inlet port 12, a test air outlet port 14, a discharge pressure gauge 16, a discharge temperature gauge 18, a valve manifold 20 including a regulating valve 22 and a diverting valve 24, and a timer 26. The test air inlet port 12 is coupled to a discharge outlet port 28 of an air compressor 30 of a vehicle during a test operation. A disposable oil in air indicator cartridge 32 is coupled to the test air outlet port 14 of the oil in air test apparatus 10, preferably by a quick connect push-on type coupling 15, to measure the amount of oil entrained in the air produced by the air compressor 30. In operation, the air test apparatus 10 simulates a normal operating load for the air compressor 30 by controlling air pressure and air flow rate to create a back pressure on the air compressor 30.

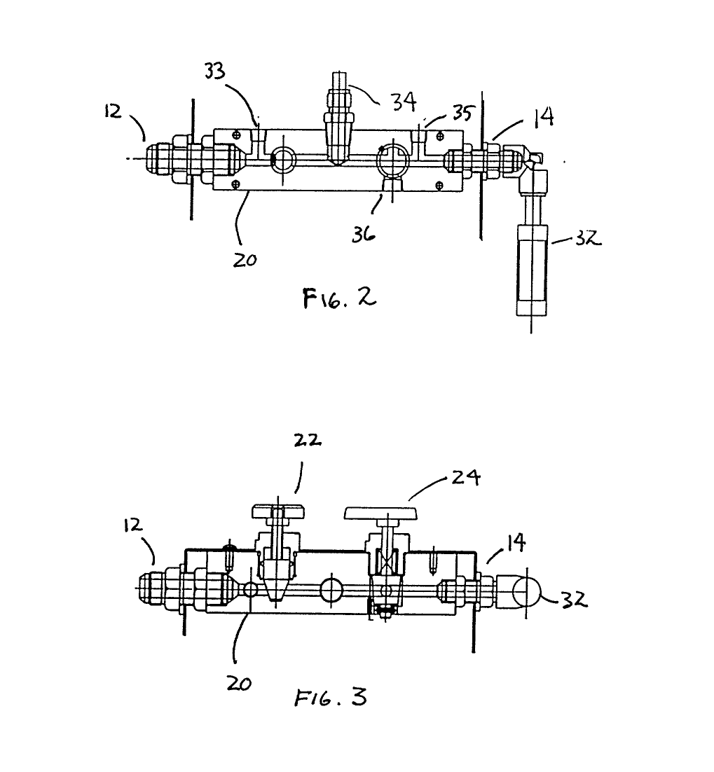

FIGS. 2 and 3 respectively illustrate front and bottom views of the valve manifold 20 provided in the air test apparatus 10. A first port 33 is provided to couple the valve manifold 20 to the discharge pressure gauge 16 and to a compressor safety valve (not shown). A thermal couple 34 is provided in the manifold that is coupled to the discharge temperature gauge 18 to measure the temperature of the air flowing through the manifold. A second port 35 is also provided to couple the manifold 20 to a downstream safety valve (not shown). The regulating valve 22 controls the amount of air supplied to the indicator cartridge 32 via the test outlet port 14, the pressure and temperature of which are respectively measured by the discharge pressure gauge 16 and discharge temperature gauge 18. The diverting valve 24 is arranged in the valve manifold 20 to selectively divert the air stream flowing through the valve manifold 20 from the test outlet port 14 to a bypass exhaust port 36.

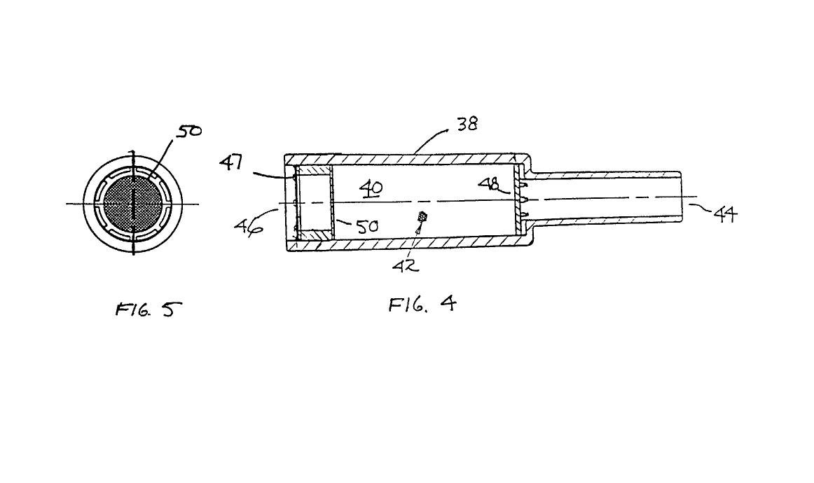

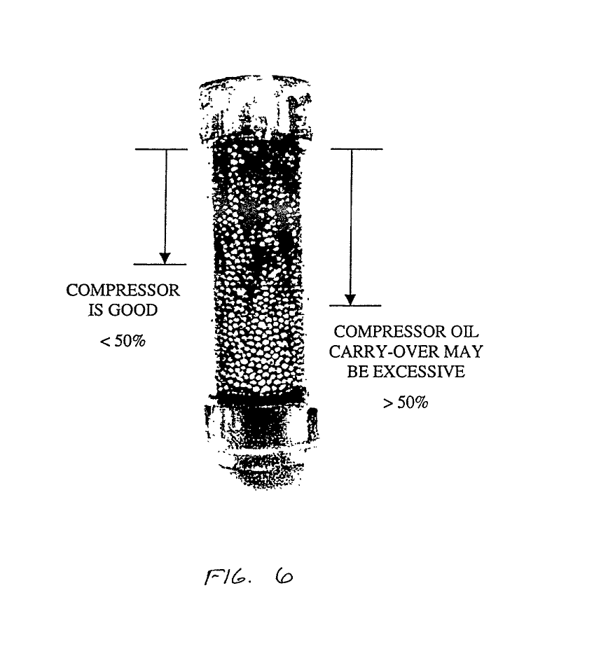

The indicator cartridge 32, shown in greater detail in FIG. 4, preferably includes a cylindrical shaped main body portion 38 that defines a cavity 40 which is filled with an oil indicator material 42. The main body portion 38 is preferably manufactured from a transparent material, such as glass or plastic, and has inlet and outlet ends 44, 46 with first and second air permeable end pieces 48, 50 respectively located therein to retain the indicator material 42 within the cavity 40 while allow air to pass through. FIG. 5 is an end view of the indicator cartridge 32 illustrating the second air permeable end piece 50 of the outlet end 46, which is held in place by a multi-wave serpentine spring 47.

In a preferred embodiment, loose bulk MOLSIV™ air brake desiccant beads, available from Union Carbide Corporation, are utilized for the oil indicator material 42. It will be understood, however, that any material that allows air to pass while being coated with oil or absorbing oil in the air stream is suitable for the indicator material 42. Fiber filters, for example, can be utilized in place of the desiccant beads. In addition, the indicator material 42 can be made from clay, ceramics, plastic beads or other organic or inorganic materials.

The initial setup of the oil in air test apparatus 10 in preparation for conducting a test will now be described. Prior to attaching the oil in air test apparatus 10 to the air compressor 30, the wheels of the vehicle under test are blocked and air pressure is drained from all of the brake reservoirs of the vehicle. The discharge line is removed from the air compressor 30 and the test air inlet 12 of the oil in air test apparatus 10 is coupled to the discharge outlet port 28 of the air compressor 30. The regulating valve 22 of the test apparatus 10 is opened to the maximum air flow rate position, and the diverting valve 24 is set to the “bypass” position to divert air passing through the valve manifold 20 to the bypass exhaust port 36.

The flow of an air stream through the oil in air test apparatus 10 is commenced by starting the engine of the vehicle under test to begin operation of the air compressor 30. The vehicle's engine is set to run at a preferred operating speed, for example 1,000 rpm, and the regulating valve 22 is manually adjusted until the discharge pressure gauge 16 reads a preferred pressure, which in the illustrated example is 140 psi. To assure that the vehicle's engine and the air compressor 30 are at their normal operating temperatures, the engine is run for a period of time, for example ten minutes, until the temperature gauge 18 reads within a desired normal operating temperature range. The oil in air test apparatus 10 is now prepared to begin testing of the air stream for entrained oil.

The test procedure is commenced by activating the timer 26 of the oil in air test apparatus 10 as the diverting valve 24 is manually turned from the “bypass” to the “test” position, thereby diverting the air stream flowing through the valve manifold 20 to the oil in air indicator cartridge 32 via the test air outlet port 14. As the air stream passes through the indicator cartridge 32, oil entrained in the air stream is deposited on the oil indicator material 42 contained in cavity 40 of the indicator cartridge 32. After a prescribed time period has elapsed, thirteen minutes in the case of the illustrated embodiment, the test is terminated by turning the diverting valve 24 back to the “bypass” position and opening the regulating valve 22 to the maximum flow position. The vehicle engine is turned off and the indicator cartridge 32 is removed from the oil in air test apparatus 10 for examination.

Visual examination of the oil in air indicator cartridge 32 is preferably used to determine whether the air compressor 30 has passed or failed the test. As shown in FIG. 6, the oil entrained in the air will start saturating the oil indicator material 42 at the inlet end 44 of the indicator cartridge 32 and then gradually progress towards the outlet end 46. The oil indicator material 42 darkens as it is coated by oil. In the illustrated example, the air compressor 30 is performing satisfactorily if less than 50% of the oil indicator material 42 is visually darkened. If more than 50% of the oil indicator material 42 is visually darkened, then there may be a problem with unsatisfactory air compressor performance, and the air compressor should be removed from the truck and sent back to the factory for warranty service.

The test apparatus provides a measurement that can be quantified and repeated with accuracy. The undesirable scenario of consumers requesting repeated air compressor replacement due to a perception of excessive oil vapor passing is thereby avoided. In addition, costs to the customer due to vehicle down time are also greatly reduced

The invention has been described with reference to certain preferred embodiments thereof. It will be understood, however, that modification and variations are possible within the scope of the appended claims. The elements within the test apparatus 10 may be reconfigured, the test parameters such as engine rpm's, temperature, test time, and test pressure will vary depending on the characteristics of the indicator cartridge 32 and the oil indicator material 42 contained therein or the compressor being tested. For example if the same test time is used for two different sized compressors, the degree of coating will necessarily vary, wherein a 50% coating might be acceptable for one compressor and unacceptable for another compressor. The indicator cartridge 32 may therefore also be provided with an indicator scale, provided either permanently as part of the indicator cartridge 32 or on a label that is attached to the indicator cartridge 32, that indicates various acceptable levels for different compressors to be tested. Also, the main body portion 38 of the disposable indicator cartridge may be formed in any desired shape or configuration. In addition, the main body portion 38 of the disposable indicator cartridge 32 need not be entirely transparent, but instead, can be a solid material with a window provided along its length, or a portion thereof, to permit viewing of the oil indicator material 42 contained therein. Further, while the illustrated embodiment utilizes manual control of the regulating valve 22 and diverting valve 24, the test apparatus may also be provided with an electronic controller to automate its operation. In such a case, for example, the automatic control can be utilized to switch the diverting valve 24 to the “bypass” position in response to a signal from the timer 26 indicating completion of the test time. Finally, while the preferred embodiment incorporates a timer 26 within the test apparatus 10 for purposes of convenience, it will be understood that any separate timing means can be utilized to determine the expiration of the desired test time.

What is claimed is:

1. An apparatus comprising:
means for receiving an air stream generated by an air compressor;
means for regulating the air stream to simulate an operating load on the air compressor; and
means for selectively directing the air stream between a test air outlet port and a bypass exhaust port.

2. An apparatus as claimed in claim 1, further comprising oil measurement means, coupled to the test air outlet port, for indicating the amount of oil in the air stream.

3. An apparatus as claimed in claim 1, further comprising means for indicating the pressure of the air stream.

4. An apparatus as claimed in claim 1, further comprising means for indicating the temperature of the air stream.

5. An apparatus comprising:
a test air inlet port;
a test air outlet port; and
a valve manifold coupled between the test air inlet port and the test air outlet port, wherein the valve manifold includes a regulating valve that regulates an air pressure of an air stream passing through the valve manifold and a diverting valve that diverts the air stream from the test air outlet port to an exhaust port.

6. An apparatus as claimed in claim 5, further comprising an oil in air indicator coupled to the test air outlet port.

7. An apparatus as claimed in claim 6, wherein the oil in air indicator includes a main body portion having an inlet end and an outlet end, wherein the main body portion is filled with an oil indicator material.

8. An apparatus as claimed in claim 7, wherein first and second air permeable end pieces are respectively located at the inlet end and the outlet end of the main body portion of the oil in air indicator.

9. An apparatus as claimed in claim 5, further comprising an air pressure gauge coupled to the valve manifold.

10. An apparatus as claimed in claim 5, further comprising an air temperature gauge coupled to said valve manifold.

11. An apparatus as claimed in claim 5, further comprising a timer.

12. An apparatus as claimed in claim 6, wherein the oil in air indicator coupled to the test air outlet port via a push-on type coupling.

13. An oil in air indicator cartridge comprising:
a hollow body with an inlet end and an outlet end; and
an oil indicator material located in the hollow body between the inlet end and the outlet end.

14. An oil in air indicator cartridge as claimed in claim 13, further comprising a first air permeable cover located at the inlet end and a second air permeable cover located at the outlet end.

15. An oil in air indicator cartridge as claimed in claim 13, wherein at least a portion of the hollow body is transparent.

16. An oil in air indicator cartridge as claimed in claim 13, wherein the hollow body had an elongated tubular shape.

17. A method for measuring a quantity of oil vapor entrained in an air compressor's air stream comprising the steps of:
attaching an oil in air test apparatus to the discharge port of an air compressor;
opening a regulating valve of the oil in air test apparatus to a maximum air flow rate position;
setting a diverting valve of the oil in air test apparatus to a bypass position to vent an air stream received from the air compressor to the atmosphere through a bypass exhaust port;
starting operation of the air compressor to generate an air stream to be tested;
adjusting the regulating valve until a predetermined pressure for the air stream to be tested is obtained; and
setting the diverting valve to a test position to direct the air stream to a test air outlet port having an oil in air indicator cartridge attached thereto for a specified time period.
